(19) United States
(12) Patent Application Publication
(10) Pub. No.: US 2025/0036545 A1
(43) Pub. Date: Jan. 30, 2025

(54) DISTRIBUTED INTELLIGENCE SYSTEMS

(71) Applicant: OrionsWave, LLC, Snoqualmie, WA (US)

(72) Inventor: Nils B. Lahr, Snoqualmie, WA (US)

(21) Appl. No.: 18/785,862

(22) Filed: Jul. 26, 2024

Related U.S. Application Data
(60) Provisional application No. 63/529,540, filed on Jul. 28, 2023.

(51) Int. Cl. G06F 11/36; G06N 3/045; G06N 3/0475

(52) U.S. Cl. CPC G06F 11/3604; G06F 11/3696; G06N 3/045; G06N 3/0475

(57) ABSTRACT

A method is disclosed for analyzing a manifest of an application. The method includes accessing an application that is tasked with performing a set of functions. The set of functions are outlined in a manifest for the application. The method further includes accessing the manifest, parsing the manifest to identify each function in the set of functions, and selecting one or more artificial intelligence (AI) models to perform each function in the set of functions.

### CROSS-REFERENCE TO RELATED APPLICATIONS

This application claims the benefit of and priority to U.S. Provisional Patent Application Ser. No. 63/529,540 filed on Jul. 28, 2023, and entitled “DISTRIBUTED INTELLIGENCE SYSTEMS,” which is incorporated herein by reference in its entirety.

### TECHNICAL FIELD

The present disclosure relates generally to distributed intelligence systems, methods, and apparatus for leveraging generative artificial intelligence (AI) and machine learning models and for utilizing efficient AI-to-AI communications between components of an intelligent system.

### BACKGROUND

Generative artificial intelligence (AI) is an emerging technology capable of producing different types of content. Such content includes images, audios, and texts. Generative AI is also able to use so-called “transformers.” A transformer is one type of machine learning (ML) model. The transformer model significantly improved the performance of machine learning tasks in various domains, especially for natural language processing (NLP).

Transformers do not eliminate the need for labeled data. Transformers still require labeled data for supervised learning tasks. What sets transformers apart is their attention mechanism, which allows the model to focus on different parts of the input data at different times. This mechanism can help identify and understand long-range dependencies in data, such as text from different sections of a book. Transformers also provide the foundation for many subsequent advancements in AI, including models like BERT, GPT, and many others, which have demonstrated impressive capabilities in text generation, text classification, and more.

Generative AI relies on the use of prompts. The prompt can be designed in any manner, such as in the form of text. The generative AI's algorithms analyze the prompt and provide content in response.

Generative AI is distinct from traditional AI in the sense that traditional AI is mainly tasked with identifying patterns in data and then making decisions based on the detected patterns. Those traditional techniques largely rely on neural networks and reinforcement learning. As mentioned above, generative AI can further rely on other techniques, which include variational autoencoders (VAEs), generative adversarial networks (GANs), transformers, and even long short-term memory. In essence, a generative AI refers to a type of intelligence model capable of learning from different examples and then creating new content based on its learning.

Copilot and Chat-based AI are just now emerging. Communications between components in a large system, such as REST-based communications, are defined using contracts. It is often the case that the input is English, and the output is English, an image, or some other type of output.

The subject matter claimed herein is not limited to embodiments that solve any disadvantages or that operate only in environments such as those described above. Rather, this background is only provided to illustrate one exemplary technology area where some embodiments described herein may be practiced.

### BRIEF SUMMARY OF THE INVENTION

Embodiments of the present disclosure relate to distributed intelligence systems, methods, and apparatus for leveraging generative artificial intelligence (AI) and machine learning models and for utilizing efficient AI-to-AI communications between components of an intelligent system. By utilizing the distributed scheme of static logic code and semantic code, the disclosed systems, methods, and storage media may increase efficiency and flexibility. Further, scalability of the systems can be improved.

According to various embodiments, a method is disclosed for analyzing a manifest of an application. The method includes accessing an application that is tasked with performing a set of functions. The set of functions are outlined in a manifest for the application. The method further includes accessing the manifest, parsing the manifest to identify each function in the set of functions, and selecting one or more AI models to perform each function in the set of functions.

According to various embodiments, a method is disclosed for facilitating operations of an application via a use of a distributed set of AI models. The method includes selecting a set of AI models to perform a set of functions of an application based on a manifest of the application, causing a first AI model in the set of AI models to perform a first operation for a first function in the set of functions, a first AI model generating output, determining that a second AI model is to perform a second operation for the first function, causing the first AI model to format the output to a scheme that is usable by the second AI model, causing the first AI model to transmit the output, which is formatted in the scheme, to the second AI model, and causing the second AI model to perform the second operation for the first function using the output from the first AI model.

According to various embodiments, a computer system is disclosed for facilitating operations of an application via a use of a distributed set of AI models. The computer system includes one or more processors, and a memory including computer executable instructions. The computer executable instructions, when executed by the one or more processors, cause the computer system to access an application that is tasked with performing a set of functions. The set of functions are outlined in a manifest for the application. The computer executable instructions further cause the computer system to access the manifest, parse the manifest to identify each function in the set of functions, and select one or more AI models to perform each function in the set of functions.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be set forth in the description which follows, and in part will be obvious from the description, or may be learned by the practice of the teachings herein. Features and advantages of the invention may be realized and obtained by means of the instruments and combinations particularly pointed out in the appended claims. Features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features can be obtained, a more particular description of the subject matter briefly described above will be rendered by reference to specific embodiments which are illustrated in the appended drawings. It should be noted that the figures are not drawn to scale, and that elements of similar structure or function are generally represented by like reference numerals for illustrative purposes throughout the figures. Understanding that these drawings depict only typical embodiments and are not therefore to be considered to be limiting in scope, embodiments will be described and explained with additional specificity and detail through the use of the accompanying drawings in which:

FIG. 1 illustrates an example architecture for analyzing an application's manifest and for using multiple artificial intelligence (AI) models to perform the functions defined in the manifest according to various embodiments of the present disclosure.

FIG. 2 illustrate a flowchart of example methods for performing functions according to various embodiments of the present disclosure.

FIG. 3 illustrates a flowchart of example methods for performing functions according to various embodiments of the present disclosure.

FIG. 4 illustrates an example computer system that can be configured to perform any of the disclosed operations according to various embodiments of the present disclosure.

### DETAILED DESCRIPTION

Significant attention is currently being focused on emerging types of AI models. These AI models are trained and then deployed to various locations. Despite being deployed, those models still generally operate in a centralized or single location.

For instance, the services of a distributed system, such as perhaps a SQL server, may be considered. The services typically run at a core location. Often, it is desirable to deploy the service at the edge of a network. To do so, what often happens is that an instance of the service is deployed to the edge, resulting in another version of the service operating at the edge. What then happens is that the edge service synchronizes with the core service. Sometimes, synchronization issues arise as a result of that configuration.

In some cases, a network edge might have its own edge. Another instance of the service might then be deployed to that sub-edge. In this scenario, three different services (e.g., the core service, the edge service, and the sub-edge service) are then tasked with synchronizing with one another, further complicating the communication process. With this configuration, it is a significant challenge to manage communications that occur in real time, particularly for cross-service or cross-application communications.

The disclosed embodiments are directed to an AI system or architecture that includes multiple AI models, each being able to work with the other models in concert to provide an overall iterative AI solution and/or an overall roll-up AI solution. Stated differently, the embodiments generally relate to a distributed intelligence system capable of utilizing efficient AI-to-AI communications between components of an even larger system. In doing so, the embodiments enable the aggregation and/or breakdown of different types and sizes of AI models. One advantage of the embodiments is that they utilize more optimal ways of transferring state, data, inferencing, logic, and context from one AI to the next, rather than relying solely on English or other high-level languages.

Beneficially, the disclosed distributed intelligence system is a hierarchical system that enables the utilization of efficient AI-to-AI communication between components in a large system. For example, consider a camera. This camera might have or might be associated with machine learning (ML) algorithms that detect motion. This motion data can be sent to a nearby device with a more powerful inferencing capability. This nearby device may then have multi-modal input, including AI, video, and Internet-of-Things (IoT) information. This device might also utilize the input to reason in a similar way to a large language model. The disclosed embodiments are also beneficially able to pass on more data to the next or downstream AI, or to infer based on its settings or knowledge which AI engine to next use and what data is needed by that engine.

The system is designed to be flexible and scalable, with different types and sizes of AI models running in many locations. The path of the data and the buildup of intelligence can be routed differently depending on the needs of the system. The system enables the aggregation and/or breakdown of different types and sizes of AI models, enabling the creation of a distributed intelligence that can evolve over time.

General AI models can be trained to know a plethora of information, such as every language spoken in the world. These models have an understanding of all the data they have been trained on, and they have a memory of those things. As a result, it is often the case that these general AI models are extremely large.

Some AI models can be trained for a specific objective or purpose. For instance, whereas the general AI model might understand all of the languages spoken by humans, a specific AI model may need to understand only the English language. These specific AI models can be trained over time, resulting in a reduction to their size as compared to the general AI model.

Generative AI models can be trained and tuned. One benefit of a generative AI model is that it does not necessarily require access to its training data after the model has been trained. Instead, the generative AI model is able to generate a training vector, which is substantially smaller in size than the actual training data but which includes all of the information learned from analyzing the training data. Thus, the training data can be decimated to a smaller form in the form of the training vector. As the generative AI model continues to learn and adapt, it also will not “forget” its previous training because it retains access to the training vector, which can continue to be modified to incorporate new knowledge.

With the training vector, the generative AI model is also provided access to its past learning. Consequently, the generative AI model can progress and can continue to make better model fitting scenarios, resulting in a higher level intelligence for the generative AI model.

The disclosed embodiments further capitalize on the expansive abilities of a generative AI model to allow one generative AI model to communicate with another generative AI model, thereby creating a hive of generative AI models that can complete a task. For instance, the embodiments are directed to a type of interlink, platform, or service that enables cross communication between different generative AI models. With the disclosed interlink, platform, or more generally “service,” the embodiments are able to operate in a multi-modal scenario in which different generative AI models may be configured differently, yet they are able to interact with one another.

In accordance with the disclosed principles, the embodiments are configured to enable multiple generative AI models (or, more simply, just “models”) to operate in unison to facilitate or complete the operations of an application. The embodiments configure the models so that they can perform an initial set of processing for the application. The model may then determine that another model can provide further information to complete the processing, thus, the model may then send its output on to a next model. Notably, the first model is configured to determine how best to format its output to enable the next model to more efficiently process that data in order to perform its respective processing.

Stated differently, each model is able to generate an output vector or data stream that is designed to be easily processed by whatever next model is tasked with performing operations to complete an application function. In some cases, the first model communicates with the second model to determine how best to configure the data. In other cases, the first model predicts or estimates how best to structure the output. In any event, the first model generates output and structures that output in a manner so that it will be readily consumable by a next model.

As a specific example, consider a scenario where an application is tasked with monitoring a video feed to detect when a particular human behavior event occurs. In accordance with the disclosed embodiments, multiple models are now linked, associated, or otherwise made available to the application to facilitate the monitoring of the video feed. A first model may be tuned to analyze video data to detect human activities. A second model may be tuned to infer human behavior based on detected activities. The second model may optionally work best when provided text input.

The first model may initially perform its functions to detect human activities. The first model has an understanding of how the second model operates, such as by understanding that it works best with text input. Consequently, the first model may generate a text output describing the human activity. As one example, the text may read as follows: “a human is detected as walking, and the human is near an ATM.” The second model may receive this input and then perform additional processing to infer what human behavior is occurring. For instance, the second model may infer that the human is likely going to withdraw cash from the ATM. In some instances, the second model may ask the first model for additional information, such as whether the human is holding an ATM card or whether the human's hand is reaching for a back pocket. From this example, one can observe how the models are able to interact and communicate with one another. Furthermore, one model can intelligently structure data so that the data has a format that is best operated on by a second model.

### Example Architecture

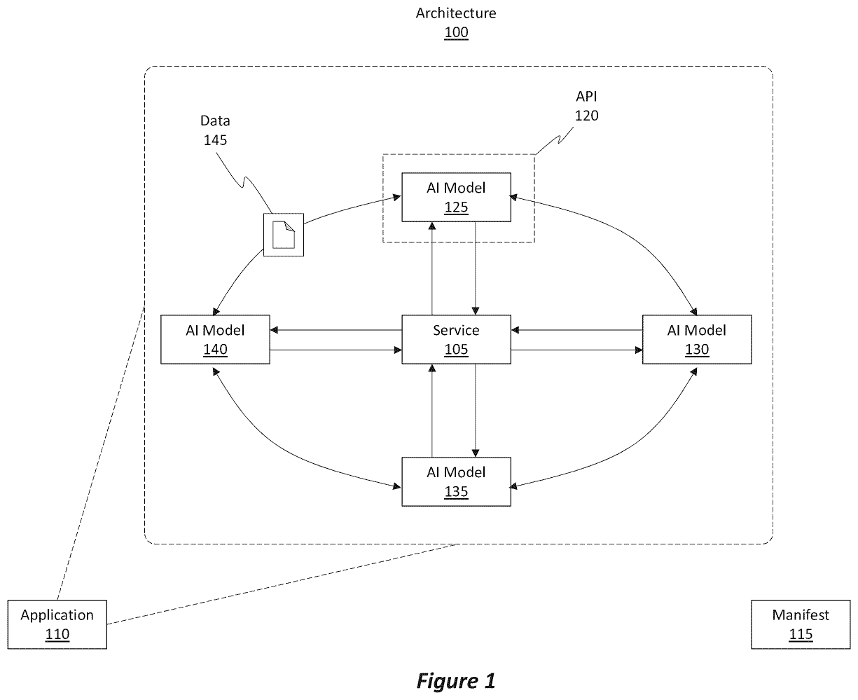

Attention will now be directed to FIG. 1, which illustrates an example architecture 100 that includes a service 105. As used herein, the term “service” refers to an automated program that is tasked with performing different actions based on input. In some cases, service 105 can be a deterministic service that operates fully given a set of inputs and without a randomization factor. In other cases, service 105 can be or can include a machine learning (ML) or artificial intelligence engine. The ML engine enables the service to operate even when faced with a randomization factor.

As used herein, reference to any type of machine learning or artificial intelligence may include any type of machine learning algorithm or device, generative AI model, convolutional neural network(s), multilayer neural network(s), recursive neural network(s), deep neural network(s), decision tree model(s) (e.g., decision trees, random forests, and gradient boosted trees) linear regression model(s), logistic regression model(s), support vector machine(s) (“SVM”), artificial intelligence device(s), or any other type of intelligent computing system. Any amount of training data may be used (and perhaps later refined) to train the machine learning algorithm to dynamically perform the disclosed operations.

In some implementations, service 105 is a cloud service operating in a cloud environment. In some implementations, service 105 is a local service operating on a local device. In some implementations, service 105 is a hybrid service that includes a cloud component operating in the cloud and a local component operating on a local device. These two components can communicate with one another.

Service 105 is tasked with facilitating the operations of an application 110. It is typically the case that application 110 includes or has associated with it a manifest 115.

An “application manifest” (or simply “manifest”) refers to an extensible markup language (XML) file for an application. The manifest describes an application's name, version, trust information, and even privileges that the application requires in order to execute. The manifest may also include dependencies the application relies on. The manifest also describes the services, file features, activities, providers and receivers associated with the application. In this sense, the manifest describes information that is considered to be essential for the application to operate, and the manifest defines the attributes of the application.

Service 105 analyzes manifest 115 and essentially breaks the manifest 115 apart into its constituent parts so as to learn the features and descriptions of application 110. With an understanding of manifest 115, service 105 can then determine how to deploy application 110 on the network as well as determine how to enable the features and functionalities of application 110.

Service 105 can then identify or select a number of models to perform, either individually or as a group, the functionalities of application 110. In some cases, these models may be incorporated into an application programming interface (API) of the application 110, such as API 120. FIG. 1 shows, in this particular example, how service 105 has selected AI models 125, 130, 135, and 140 to perform the operations of application 110. Notice, AI model 125 is included as a part of API 120.

The various AI models are able to communicate with service 105, as generally shown by the lines connecting the AI models to service 105. Also, the AI models are able to communicate with one another, as generally shown by the lines connecting the AI models.

Each AI model is able to analyze and process information. In some instances, an AI model may perform an initial amount of processing and then determine that another AI model is likely able to provide a better result. Consequently, one AI model can generate output and then transmit that output to another AI model to process. For instance, data 145 may be the output generated by AI model 125. AI model 125 is transmitting data 145 to AI model 140 to perform further processing.

Notably, AI model 125 has an understanding of how best to format or structure data 145 to conform with a structure used by AI model 140. Thus, one AI model can modify or otherwise structure its output data so that the data will be easily received and processed by a next AI model. Optionally, the data used by the AI model 125 can be verbose, including states, matrices, attention, and content. AI model 125 can structure its output data 145 to be of a complex data type.

Accordingly, an application can be determined to have multiple different functionalities and features that are available for use. The embodiments are directed to a type of service that can identify the features of that application. The service can also identify corresponding AI models that are tuned or tasked with or that are optimized with being able to perform the specific features of the application. The service is able to effectively break apart the application, or rather, have the application be serviced by these multiple different AI models, which are fine tuned for those specific operations. The architecture is also designed to enable crosstalk or cross communication between those multiple different AI models that are servicing the features of the application.

Because the embodiments rely on AI models 125, 130, 135, and 140, the embodiments are not bound by a specific structure or format for data 145. Indeed, it may be the cases that an AI model uses a first format when first communicating with a second AI model but then subsequently uses a second format when later communicating with that same, second AI model. For example, the first format may include sets of rules and procedures for processing data 145 and making decisions. In this regard, the first format may be programming code or instructions in a programming language, such as Python, Java, C, SQL, or any other language. The second format may be semantically run by one or more AI modules. Thus, the embodiments are highly dynamic and can beneficially allow different formatting schemes to be used at different times. For instance, one reason the formatting scheme may change over time is because each AI model can continue to learn and improve. As the AI models learn and improve over time, they might operate better with a different formatting scheme. Thus, the embodiments can avoid or refrain from hardcoding a specific format or scheme. Instead, the embodiments promote modification and improvement over time.

The embodiments are also configured to determine when an AI model should be used and when a deterministic model or routine should be used. For example, if an application's function is static in its operations, then there may not be a need to have an AI model perform that function. Service 105 can then swap out the AI model for a deterministic model structured to perform the static operation. As a result, service 105 can fine tune the operations of application 110 over time in order to increase efficiencies for the application 110. For example and without limitations, a semantic kernel, which is an open source development kit designed to facilitate integration of AI models, allows interchangeable usages of the AI model and a deterministic model structured to perform the static operation in a single location, thereby increasing efficiencies of the application 110. In other words, the embodiments may combine static logic code and semantic code based on a type of functionalities to be performed in the application 110. In an embodiment, a function of the application 110 may be performed by using either one or both of the static logic code and the semantic code run by the AI models, which are assigned to perform the function.

The static logic code may be compiled code based on a set of rules and procedures. In other words, the static logic code performs predetermined or preprogrammed functions regardless of situation. On the other hand, the semantic code may dynamically perform various functions in response to situations or embodiments.

In embodiments, this approach of combining the static logic code and the semantic code may be employed in robotics. Emergency stops may utilize the static logic code, while recognition of objects or understanding of environments may utilize the semantic code by AI models. By employing static logic code and semantic code in various situations, robots may function as planned in various situations. Thereby, example architecture 100 may efficiently, flexibly function. Further, scalability of example architecture 100 can be improved. Further, by dynamically switching between the semantic code and the static logic code in response to dynamically varying situations and environments, example architecture 100 may be suitable for building a multi-layered smart city.

In some implementations, data 145 can also be formatted as a data stream that exists between AI model 125 and AI model 140. This data stream can continuously flow between those two models. The stream can include any type of multi-modal information.

Each AI model is also able to employ its intelligence to make assumptions or inferences based on the data and based on the functionalities of application 110. These assumptions and inferences can be compounded over time as multiple different AI models are brought in to perform operations. Regarding the training and information vector mentioned earlier, the embodiments are able to add to this vector to increase the amount of learning the AI models have over time. Thus, the quality of the assumptions can be improved over time as well.

### Example Methods

The following discussion now refers to a number of methods and method acts that may be performed. Although the method acts may be discussed in a certain order or illustrated in a flow chart as occurring in a particular order, no particular ordering is required unless specifically stated, or required because an act is dependent on another act being completed prior to the act being performed.

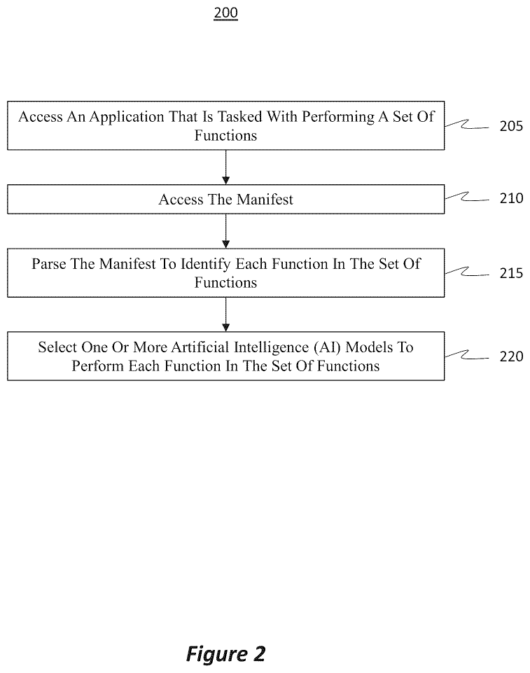

Attention will now be directed to FIG. 2, which illustrates a flowchart of an example method 200 for analyzing a manifest for an application to determine how to handle the operations of that application. Method 200 can be implemented within architecture 100 of FIG. 1. Further, method 200 can be performed by service 105 of FIG. 1.

Method 200 includes an act (act 205) of accessing an application that is tasked with performing a set of functions. The set of functions are outlined in a manifest for the application.

Act 210 includes accessing the manifest, which may be saved in a storage medium, such as a hard disk drive, solid state drive, universal serial bus storage, tape, compact disk, or any other comparable storage device. The manifest may provide an organized way to define all functions of the application, to manage dependencies of the functions to perform the application, to specify permissions needed by the application, and to specify configuration and environment-specific settings to facilitate deployment and scaling of the application.

Act 215 includes parsing the manifest to identify each function in the set of functions. Specifically, based on tags of the XML language, each function and corresponding dependencies and settings are identified.

Act 220 includes selecting one or more artificial intelligence (AI) models to perform each function in the set of functions.

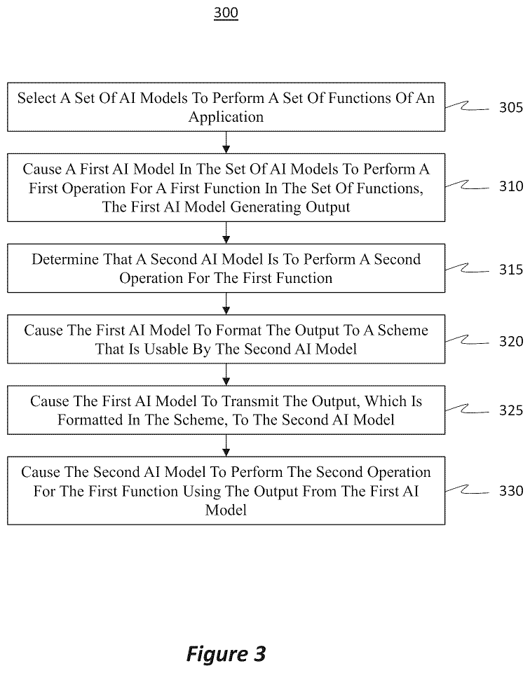

FIG. 3 shows a flowchart of an example method 300 for facilitating operations of an application via the use of a distributed set of artificial intelligence (AI) models. Method 300 can also be implemented by service 105 based on manifest 115 of FIG. 1. The application may be performed by executing a set of functions.

Act 305 includes selecting a set of AI models to perform one of a set of functions of an application. Act 305 is related to act 220 of FIG. 2. Act 305 may further includes selecting a respective set of AI models for each function of the set of functions.

Act 310 includes causing a first AI model in the set of AI models to perform a first operation for a first function in the set of functions. Notably, the first AI model generates output.

Act 315 includes determining that a second AI model is to perform a second operation for the first function.

Act 320 includes causing the first AI model to format the output according to a scheme that is usable by the second AI model.

Act 325 includes causing the first AI model to transmit the output to the second AI model. Notably, the output is formatted in the scheme.

Act 330 includes causing the second AI model to perform the second operation for the first function using the output from the first AI model. In an embodiment, the second AI model may perform the second operation for a second function using the output from the first AI model. In another embodiment, two or more operations may be performed for one function.

### Example Computer/Computer Systems

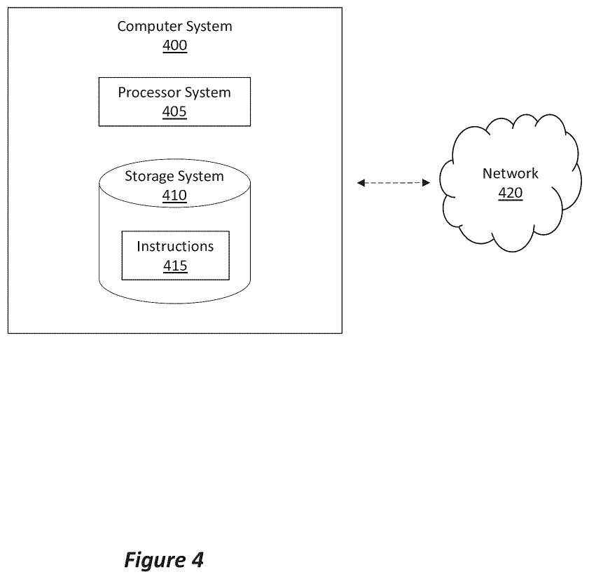

Attention will now be directed to FIG. 4, which illustrates an example computer system 400 that may include and/or be used to perform any of the operations described herein. Computer system 400 may take various different forms. For example, computer system 400 may be embodied as a tablet, a desktop, a laptop, a mobile device, or a standalone device, such as those described throughout this disclosure. Computer system 400 may also be a distributed system that includes one or more connected computing components/devices that are in communication with computer system 400. Computer system can implement service 105 of FIG. 1. Architecture 100 can also be implemented on computer system 400. In an embodiment, various computer systems may implement service 105 or architecture 100 in a distributed matter.

In its most basic configuration, computer system 400 includes various different components. FIG. 4 shows that computer system 400 includes a processor system 405 comprising one or more processor(s) (aka a “hardware processing unit”) and a storage system 410.

Regarding the processor(s) of the processor system 405, it will be appreciated that the functionality described herein can be performed, at least in part, by one or more hardware logic components (e.g., the processor(s)). For example and without limitation, illustrative types of hardware logic components/processors that can be used include Field-Programmable Gate Arrays (“FPGA”), Program-Specific or Application-Specific Integrated Circuits (“ASIC”), Program-Specific Standard Products (“ASSP”), System-On-A-Chip Systems (“SOC”), Complex Programmable Logic Devices (“CPLD”), Central Processing Units (“CPU”), Graphical Processing Units (“GPU”), or any other type of programmable hardware by performing the basic arithmetic, logical, control and input/output (I/O) operations specified by the instructions.

A general-purpose computer, special purpose computer, or special purpose processing device also includes a display, which may be a cathode ray tube (CRT), a liquid crystal display (LCD), light emitting diode (LED), or an organic light emitting diode (OLED) display. In some embodiments, the OLED display is a passive-matrix OLED (PMOLED) or active-matrix OLED (AMOLED) display. In other embodiments, the display may be a touch screen, through which alphanumerals may be input or entered. In still other aspects, the display may be a hologram, through which users may enter data by touching or swiping space.

Data or commands may be entered via an input device in the special purpose or general-purpose computer. The input device may be a keyboard, a mouse, a touch screen, or a hologram keyboard.

As used herein, the terms “executable module,” “executable component,” “component,” “module,” “service,” or “engine” can refer to hardware processing units or to software objects, routines, or methods that may be executed on computer system 400. The different components, modules, engines, and services described herein may be implemented as objects or processors that execute on computer system 400 (e.g., as separate threads).

Storage system 410 may be physical system memory, which may be volatile, non-volatile, or some combination of the two. The term “memory” may also be used herein to refer to non-volatile mass storage such as physical storage media. If computer system 400 is distributed, the processing, memory, and/or storage capability may be distributed as well.

Storage system 410 is shown as including executable instructions 415. The executable instructions 415 represent instructions that are executable by the processor(s) of the processor system 405 to perform the disclosed operations, such as those described in the various methods.

The disclosed embodiments may comprise or utilize a special-purpose or general-purpose computer including computer hardware, such as, for example, one or more processors and system memory, as discussed in greater detail below. Embodiments also include physical and other computer-readable media for carrying or storing computer-executable instructions and/or data structures. Such computer-readable media can be any available media that can be accessed by a general-purpose or special-purpose computer system. Computer-readable media that store computer-executable instructions in the form of data are “physical computer storage media” or a “hardware storage device.” Furthermore, computer-readable storage media, which includes physical computer storage media and hardware storage devices, exclude signals, carrier waves, and propagating signals. On the other hand, computer-readable media that carry computer-executable instructions are “transmission media” and include signals, carrier waves, and propagating signals. Thus, by way of example and not limitation, the current embodiments can comprise at least two distinctly different kinds of computer-readable media: computer storage media and transmission media.

Computer storage media (aka “hardware storage device”) are computer-readable hardware storage devices, such as RAM, ROM, EEPROM, CD-ROM, solid state drives (“SSD”) that are based on RAM, Flash memory, phase-change memory (“PCM”), or other types of memory, or other optical disk storage, magnetic disk storage or other magnetic storage devices, or any other medium that can be used to store desired program code means in the form of computer-executable instructions, data, or data structures and that can be accessed by a general-purpose or special-purpose computer.

Computer system 400 may also be connected (via a wired or wireless connection) to external sensors (e.g., one or more remote cameras) or devices via a network 420. For example, computer system 400 can communicate with any number devices or cloud services to obtain or process data. In some cases, network 420 may itself be a cloud network. Furthermore, computer system 400 may also be connected through one or more wired or wireless networks to remote/separate computer systems(s) that are configured to perform any of the processing described with regard to computer system 400.

A “network,” like network 420, is defined as one or more data links and/or data switches that enable the transport of electronic data between computer systems, modules, and/or other electronic devices. When information is transferred, or provided, over a network (either hardwired, wireless, or a combination of hardwired and wireless) to a computer, the computer properly views the connection as a transmission medium. Computer system 400 will include one or more communication channels that are used to communicate with the network 420.

Transmissions media include a network that can be used to carry data or desired program code means in the form of computer-executable instructions or in the form of data structures. Further, these computer-executable instructions can be accessed by a general-purpose or special-purpose computer. Combinations of the above should also be included within the scope of computer-readable media.

Upon reaching various computer system components, program code means in the form of computer-executable instructions or data structures can be transferred automatically from transmission media to computer storage media (or vice versa). For example, computer-executable instructions or data structures received over a network or data link can be buffered in RAM within a network interface module (e.g., a network interface card or “NIC”) and then eventually transferred to computer system RAM and/or to less volatile computer storage media at a computer system. Thus, it should be understood that computer storage media can be included in computer system components that also (or even primarily) utilize transmission media.

Computer-executable (or computer-interpretable) instructions comprise, for example, instructions that cause a general-purpose computer, special-purpose computer, or special-purpose processing device to perform a certain function or group of functions. The computer-executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the embodiments may be practiced in network computing environments with many types of computer system configurations, including personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, and the like. The embodiments may also be practiced in distributed system environments where local and remote computer systems that are linked (either by hardwired data links, wireless data links, or by a combination of hardwired and wireless data links) through a network each perform tasks (e.g., cloud computing, cloud services and the like). In a distributed system environment, program modules may be located in both local and remote memory storage devices.

The present invention may be embodied in other specific forms without departing from its characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method for analyzing a manifest of an application, the method comprising:
accessing an application that is tasked with performing a set of functions, wherein the set of functions are outlined in a manifest for the application;
accessing the manifest;
parsing the manifest to identify each function in the set of functions; and
selecting one or more artificial intelligence (AI) models to perform each function in the set of functions.

2. The method according to claim 1, wherein selecting the one or more AI models includes interchangeably swapping static logic code and semantic code based on an identified function.

3. The method according to claim 2, wherein the semantic code is run by the one or more AI models.

4. The method according to claim 2, wherein the static logic code is compiled code based on a set of rules and procedures.

5. The method according to claim 2, wherein interchangeably swapping static logic code and semantic code is performed by a semantic kernel.

6. The method according to claim 1, wherein the manifest of the application includes a name, a version, trust information, and privileges that the application requires to execute.

7. The method according to claim 1, wherein the manifest of the application is described in an extensible markup language.

8. A method for facilitating operations of an application via a use of a distributed set of artificial intelligence (AI) models, the method comprising:
selecting a set of AI models to perform a set of functions of an application based on a manifest of the application;
causing a first AI model in the set of AI models to perform a first operation for a first function in the set of functions, a first AI model generating output;
determining that a second AI model is to perform a second operation for the first function;
causing the first AI model to format the output to a scheme that is usable by the second AI model;
causing the first AI model to transmit the output, which is formatted in the scheme, to the second AI model; and
causing the second AI model to perform the second operation for the first function using the output from the first AI model.

9. The method according to claim 8, wherein selecting the set of AI models includes interchangeably swapping static logic code and semantic code based on an identified function.

10. The method according to claim 9, wherein the semantic code is run by the set of AI models.

11. The method according to claim 9, wherein the static logic code is compiled code based on a set of rules and procedures.

12. The method according to claim 9, wherein interchangeably swapping static logic code and semantic code is performed by a semantic kernel.

13. The method according to claim 8, wherein the manifest of the application includes a name, a version, trust information, and privileges that the application requires to execute.

14. The method according to claim 7, wherein the manifest of the application is described in an extensible markup language.

15. A computer system for facilitating operations of an application via a use of a distributed set of artificial intelligence (AI) models, the computer system comprising:
one or more processors; and
a memory including computer executable instructions that, when executed by the one or more processors, cause the computer system to:
access an application that is tasked with performing a set of functions, wherein the set of functions are outlined in a manifest for the application;
access the manifest;
parse the manifest to identify each function in the set of functions; and
select one or more artificial intelligence (AI) models to perform each function in the set of functions.

16. The computer system according to claim 15, wherein selection of the one or more AI models is performed by interchangeably swapping static logic code and semantic code based on an identified function.

17. The computer system according to claim 16, wherein the semantic code is run by the one or more AI models.

18. The computer system according to claim 16, wherein the static logic code is compiled code based on a set of rules and procedures.

19. The computer system according to claim 16, wherein interchangeably swapping static logic code and semantic code is performed by a semantic kernel.

20. The computer system according to claim 15, wherein the manifest of the application includes a name, a version, trust information, and privileges that the application requires to execute.
